(19) United States
(12) Patent Application Publication
(10) Pub. No.: US 2007/0070801 A1
(43) Pub. Date: Mar. 29, 2007

(54) PRE-COMBUSTION MIX DRUM

(75) Inventors: JOSEPH E. MUSIL, ELY, IA (US); DAVID EMERSON, OKLAHOMA CITY, OK (US); MARK SPICER, OCALA, FL (US)

Correspondence Address: SIMMONS PERRINE PLC, THIRD FLOOR TOWER PLACE, 22 SOUTH LINN STREET, IOWA CITY, IA, 52240, US

(73) Assignee: CEDARAPIDS, INC., CEDAR RAPIDS, IA (US)

(21) Appl. No.: 11/534,448

(22) Filed: Sep. 22, 2006

Related U.S. Application Data
(60) Provisional application No. 60/596,448, filed on Sep. 23, 2005.

(51) Int. Cl. B28C 5/46

(52) U.S. Cl. 366/7; 366/25

(57) ABSTRACT

A counter flow VAM and RAP asphalt plant having concentric drums, each with a conveyor for introducing material, the concentric drums with a plurality of passages between them permitting material to move from the inner drum to the outer drum and from the outer drum into the inner drum, thereby permitting at least some material to proceed through the asphalt plant and bypass direct exposure to high temperature flame emitted by an internal burner.

### CROSS REFERENCE TO RELATED APPLICATIONS

This application claims the benefit of a provisional application filed on Sep. 23, 2005, and having Ser. No. 60/596,448.

### BACKGROUND OF THE INVENTION

This invention relates to a counter-flow asphalt plant used to produce a variety of asphalt compositions. More specifically, this invention relates to a counter-flow asphalt plant having a recycle asphalt pavement (RAP) feed to produce blended virgin aggregate material (VAM)/RAP mixes.

Several techniques and numerous equipment arrangements for the preparation of asphaltic cement, also referred to by the trade as “hotmix” or “HMA”, are known from the prior art. Particularly relevant to the present invention is the continuous production of asphalt compositions in a drum mixer asphalt plant. Typically, moisture-laden VAM are dried and heated within a rotating, open-ended drum mixer through radiant, convective and conductive heat transfer from a stream of hot gases produced by a burner flame. As the heated VAM flows through the drum mixer, it is combined with liquid asphalt and mineral binder to produce an asphaltic composition as the desired end-product. However, often, prior to mixing the virgin aggregate and liquid asphalt, previously crushed RAP is added. The RAP is typically mixed with the heated VAM in the drum mixer at a point prior to adding the liquid asphalt and mineral fines.

The asphalt industry has traditionally faced many environmental challenges. The drum mixer characteristically generates, as by-products, a gaseous hydrocarbon emission (known as blue smoke), various nitrogen oxides (NOₓ) and sticky dust particles covered with asphalt. Early asphalt plants exposed the liquid asphalt or RAP material to excessive temperatures within the drum mixer or put the materials in close proximity with the burner flame, which caused serious product degradation. Health and safety hazards resulted from the substantial air pollution control problems due to the blue smoke produced when hydrocarbon constituents in the asphalt are driven off and released into the atmosphere.

The earlier environmental problems were further exacerbated by the processing technique standard in the industry which required the asphalt ingredients with the drum mixer to flow in the same direction (i.e., co-current flow) as the hot gases for heating and drying the aggregate. Thus, the asphalt component of recycle material and liquid asphalt itself came in direct contact with the hot gas stream and, in some instances, even the burner flame itself.

Many of the earlier problems experienced by asphalt plants were solved with the development of modern day counter-flow technology as disclosed in U.S. Pat. Nos. 4,787,938 and 6,672,751 to Hawkins, which are incorporated herein by this reference. The asphalt industry began to standardize on the counter-flow processing technique in which the ingredients of the asphaltic composition and the hot gas stream flow through a single, rotating drum mixer in opposite directions. Combustion equipment extends into the drum mixer to generate the hot gas stream at an intermediate point within the drum mixer. Accordingly, the drum mixers have included three zones. From the end of the drum where the VAM feeds, the three zones include a pre-combustion zone to dry and heat material, a combustion zone to generate a hot gas stream for the drying/heating zone, and a post-combustion zone to mix hot aggregate, RAP and liquid asphalt to produce an asphaltic composition for discharge from the lower end of the drum mixer.

Not only did the counter-flow process with its three zones vastly improve heat transfer characteristics, but more importantly, it provided a process in which the liquid asphalt and recycle material were isolated from the burner flame and the hot gas stream generated by the combustion equipment. Counter-flow operation represented improvement with respect to the vexing problem of blue smoke and health and safety hazards associated with blue smoke.

With many of the health and safety issues associated with asphalt production solved by the advent of counter-flow technology, contemporaneous attention has now shifted to operational inefficiencies which are manifest as excessive design and production costs and poor economy of operation from excess energy consumption.

Experience has shown that the environmentally desirable use of a RAP in asphalt production comes with disadvantageous tradeoffs in energy consumption. In some circumstances, for example, all VAM is introduced in one end of the dryer and flows as a falling curtain or veil of material in counter-current heat exchange with hot gases generated at the opposite end of the dryer. The shell temperature is characteristically about 500 degrees F., and the exhaust gas is about 225 degrees F., which is within the normal operating temperature for the baghouse used to filter the exhaust gas of particulate matter. The temperature of the exhaust gas stream is determined by the design of the dryer, but must be kept above dew point to prevent moisture from condensing in the exhaust ductwork and especially in the baghouse itself. A temperature of 225 degrees F. is sufficient, but since varying conditions during operation can cause relatively large temperature swings, most operations are controlled to keep exhaust temperatures in the range of 250 degrees F. to 275 degrees F.

Typically, the addition of RAP material has a significant effect on operating temperatures of the process. Since RAP cannot be exposed to temperatures above a combustion threshold without burning the liquid asphalt and causing hydrocarbon smoke emissions, it is often dried indirectly by superheating the virgin aggregates and then mixing the superheated aggregates with the RAP to achieve a mixed mixture temperature. This results in much higher exhaust gas temperatures and a resulting loss in fuel efficiency. Accordingly, 20 to 40% RAP feeds (that is, operations wherein RAP makes up 20 to 40% of the final asphalt composition) have been close to the upper end of the range heretofore workable in modern counter-flow asphalt plants. Although a 50% RAP feed is achievable, it has been at the cost of high energy and reduced equipment life. Consequently, an upper limit of approximately 40% RAP has been a realistic upper limit for the majority of asphalt plants. The operating conditions necessary are illustrative of the problems. If 50% RAP is introduced midstream in the process, then only 50% virgin aggregates are used. This means that only half the material is present, as compared to the 100% virgin aggregate production, to be heated and only half the veiling of material in the drying section of the drum occurs which yields poor heat transfer characteristics. Under such circumstances, the combustion zone temperature must be elevated significantly to superheat the virgin aggregate. This, in turn, causes shell temperature of the drum to range from 750-800 degrees F. and exhaust gas temperature to increase to about 375 degrees F. Moreover, any time the combustion zone temperature rises to about 2800 degrees F. or greater, then the production of various nitrogen oxides (NOx) as a product of combustion may become a problem.

A need remains in the industry for an improved counter-flow asphalt plant design capable of utilizing high percentage RAP mixes and for operating techniques to address the problems and drawbacks heretofore experienced with modern counter-flow production. The primary objective of this invention is to meet this need.

### SUMMARY OF THE INVENTION

More specifically, an object of the invention is to provide a counter-flow asphalt plant capable of routinely using high percentage RAP mixes without emitting excessive blue smoke or without excessive energy requirements.

Another object of the invention is to provide a counter-flow asphalt plant capable of processing high RAP mixes with extended equipment life by eliminating the need to superheat virgin aggregates with the associated temperature elevation of the processing equipment.

An alternative object of the invention is to provide a counter-flow asphalt plant capable of processing RAP mixes by utilizing reduced superheating processes, together with the processing techniques which are the subject of this invention.

A further object of the invention is to provide a counter-flow drum mixer with specially designed pre-combustion zone flighting and drum wall orifices to permit virgin material to be pre-mixed with RAP material which has been introduced into a partial outer drum before the beginning of the combustion zone.

Yet another object of the invention is to provide counter-flow drum mixer and method of operation for reducing NOx emissions for processing techniques utilizing RAP with virgin material mixes.

Another object of the invention is to provide counter-flow drum mixer and method of operation for which the exhaust gas temperatures are substantially lower than in many conventional systems (320 degrees F. vs. 375 degrees F. average in a typical 40% recycle plant).

A further object of the invention is to provide a counter-flow asphalt plant of the character described which is both safe and economical in operation. Efficient operation results in improved fuel consumption and in reduced air pollution emissions.

Other and further objects of the invention, together with the features of novelty appurtenant thereto, will appear in the detailed description of the drawings.

In summary, a counter-flow aggregate dryer for an asphalt plant is equipped with a partial outer drum around a main drum, where the partial outer drum provides for a secondary front loading feeder for early introduction of RAP materials and providing a place for combining RAP with heated virgin material before the beginning of the combustion zone of the main drum. Adjustably sized and located orifices in the wall of the main drum in the pre-combustion zone permit regulation of heated virgin material dropping down into the partial outer drum, which is then premixed with the RAP material and together are carried around the combustion zone and away from direct radiant heat of the combustion zone to the post combustion zone for additional mixing.

### BRIEF DESCRIPTION OF THE DRAWINGS

In the following description of the drawings, in which like reference numerals are employed to indicate like parts in the various views:

FIG. 1 is a side sectional view of a prior art counter-flow asphalt plant, with a RAP introduction point in the post-combustion zone, in order to compare and contrast the teachings of this invention.

FIG. 2 is a side sectional view of a prior art counter-flow asphalt plant, with a RAP introduction point in the combustion zone, in order to compare and contrast the teachings of this invention.

FIG. 3 is side sectional view of a counter-flow asphalt plant of the present invention with an outer partial drum and a front loading RAP introduction point in the pre-combustion zone.

FIG. 4 is a cut-away perspective view of an embodiment of a counter-flow asphalt plant of the present invention, generally designated 400, wherein a front portion of the main drum 402, the outer drum 404 and burner have been removed to expose the details of the inside.

FIG. 5 is a perspective view of a middle section of the asphalt plant of FIG. 4, where the outer drum 404 is not shown so as to better reveal the details of the outer surface of the main drum 402.

### DETAILED DESCRIPTION OF THE DRAWINGS

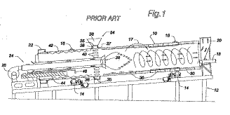

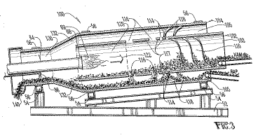

Referring now to the drawings, where like numerals refer to like matter throughout, and referring in greater detail, attention is first directed to a prior art counter-flow asphalt plant as shown in the prior art illustration of FIG. 1 for the purposes of subsequently comparing and contrasting the structure and operation of an asphalt plant constructed in accordance with this invention as illustrated in FIG. 3. The prior art asphalt plant of FIG. 1 is shown and described in greater detail in Hawkins U.S. Pat. No. 4,787,938 incorporated herein by reference.

The prior art counter-flow plant includes a substantially horizontal, single drum mixer 10 carried by a ground engaging support frame 12 at a slight angle of declination, typically about 5 degrees. Mounted on the frame 12 are two pairs of large, motor driven rollers 14 which supportingly receive trunnion rings 16 secured to the exterior surface of the drum mixer 10. Thus, rotation of the drive rollers 14 engaging the trunnion rings 16 causes the drum mixer 10 to be rotated about its central longitudinal axis in the direction of the rotational arrow 17.

Located at the inlet or upstream end of the drum mixer 10 is an aggregate feeder 18 to deliver aggregate to the interior of the drum mixer 10 from a storage hopper or stockpile (not shown). The inlet end of the drum mixer 10 is closed by a flanged exhaust port 20 leading to conventional air pollution control equipment (not shown), such as a baghouse, to remove particulates from the gas stream.

Located at the outlet end of the drum mixer 10 is a discharge housing 22 to direct asphaltic composition from the drum mixer 10 to a material conveyor (not shown) for delivery of the final product to a storage bin or transporting vehicle.

A combustion assembly 24 extends through the discharge housing 22 and into the drum mixer 10 to deliver fuel, primary air from a blower 26 and induced secondary air through an open annulus to a burner head 28. Combustion at the burner head 28 generates a hot gas stream which flows through the drying zone of the drum mixer 10. Within the drying zone are fixed various types of flights or paddles 30 for the alternative purposes of lifting, tumbling, mixing, and moving aggregate within the drum mixer 10 to facilitate the drying and heating of the aggregate therein.

Downstream of the burner head 28 is located the recycle feed assembly 34 by which recycle asphalt material may be introduced into the drum mixer 10. A stationary box channel 35 encircles the exterior surface of the drum mixer 10 and includes a feed hopper 36 providing access to the interior of the box channel 35. Bolted to the side walls of the box channel 35 are flexible seals 37 to permit rotation of the drum mixer 10 within the encircling box channel 35. Secured to the outer wall of the drum mixer 10 and projecting into the space defined by the box channel 35 is a plurality of scoops 38 radially spaced around the drum mixer 10. At the bottom of each scoop 38 is a scoop opening 40 through the wall of the drum mixer 10 to provide access to the interior of drum mixer 10. Thus, recycle asphalt material may be delivered by conveyor (not shown) through the feed hopper 36, into the box channel 35 and subsequently introduced into the interior of the drum mixer 10 through the scoop openings 40.

Downstream of the recycle feed assembly 34 is a mixing zone within the drum mixer 10. Mounted on the interior thereof are staggered rows of sawtooth flighting 42 to mix and stir material within the annulus of the drum mixer 10 and combustion assembly 24. A conveyor 44 extends into the drum mixer 10 for feeding binder material or mineral “fines” to the mixing zone. Likewise extending into the drum mixer 10 is an injection tube 46 for spraying liquid asphalt into the mixing zone. At the end of the mixing zone is located the discharge housing 22, as previously discussed, through which the asphaltic product is discharged.

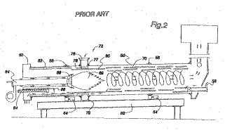

Now referring to FIG. 2, there is shown another prior art design of a counter-flow asphalt plant for the purpose of subsequently comparing and contrasting the structure and operation of an asphalt plant constructed in accordance with this invention as illustrated in FIG. 3. The prior art asphalt plant of FIG. 2 is shown and described in greater detail in Hawkins U.S. Pat. No. 6,672,751, incorporated herein by reference.

Turning then to the prior art asphalt plant configuration shown in FIG. 2, the counter-flow plant includes a substantially horizontal, single cylindrical drum 50 carried by a ground engaging support frame 52 at a slight angle of declination, typically about 5 degrees. Mounted on the frame 52 are two pairs of large, motor driven rollers 54 which supportingly receive trunnion rings 56 secured to the exterior surface of the drum 50. Thus, rotation of the drive rollers 54 engaging the trunnion rings 56 causes the drum 50 to be rotated about its central longitudinal axis.

Located at the inlet or upstream end of the drum 50 is an aggregate feeder 58 to deliver aggregate to the interior of the drum 50 from a storage hopper or stockpile (not shown).

Located at the outlet end of the drum 50 is a discharge housing 62 to direct asphaltic composition from the drum 50 to a material conveyor (not shown) for delivery of the final product to a storage bin or transporting vehicle.

A combustion assembly 64 extends through the discharge housing 62 and into the drum 50 to deliver fuel, primary air from a blower 66 and induced secondary air through an open annulus to a burner head 68. Combustion of the air and fuel within the combustion zone of the drum 50 which generally extends from the burner head 68 to the end of the flame envelope 69 generates a hot gas stream which flows through the drying zone of the drum 50. Within the drying zone, material flights 70 are secured to the interior surface of the drum 50 to lift, tumble, mix, and release aggregate material within the drum 50 to create a substantially continuous veil or curtain of falling material through which the hot gas stream passes in counter-current flow to facilitate the drying and heating of the aggregate.

Early conventional wisdom of asphalt plant design and operation positions the RAP feed downstream of the burner head as illustrated in FIG. 1. Now referring to FIG. 2, the later prior art design departs from early conventional wisdom, however, and locates the recycle feed assembly 72 upstream of the burner head 68 and intermediate the ends of the combustion zone. The recycle feed assembly 72 may be utilized to introduce recycle asphalt material, virgin material, or a mixture of recycle and virgin material into the drum 50. A stationary box channel 75 encircles the exterior surface of the drum 50 and includes a feed hopper 76 providing access to the interior of the box channel 75. Bolted to the side walls of the box channel 75 are flexible seals 77 to permit rotation of the drum 50 within the encircling box channel 75. Thus, for example, recycle asphalt material may be delivered by conveyor (not shown) through the feed hopper 76, into the box channel 75 and subsequently introduced into the interior of the drum 50 through the scoop openings 78.

Within the combustion zone are mounted a plurality of combustion flights 80 which are spaced apart from the interior surface of the drum shell 50 to provide an annulus region through which material may be carried. It is specifically important to this prior art design that the combustion flights 80 are non-veiling flights to prevent material from falling through the flame envelope 69, as distinguished from the dryer flights 70, which are veiling flights for the intended purpose of creating a continuous curtain of falling material in the heating/drying zone.

Downstream of the burner head 68 is a mixing zone within the drum 50. Mounted on the interior thereof are rows of mixer flighting 82 to mix and stir material within the annulus formed by the drum 50 and combustion assembly 64. An auger 84 extends into the drum 50 for feeding binder material or mineral “fines” to the mixing zone. Likewise extending into the drum 50 is an injection tube 86 for spraying liquid asphalt into the mixing zones. At the end of the mixing zone is located the discharge housing 62 as previously discussed through which the asphaltic product is discharged.

Now referring to FIG. 3, there is shown a counter-flow asphalt drum of the present invention generally designated 100, having a main drum 102 with a main drum front end opening 103 and a partial outer drum 104 with a partial outer drum front end opening 105.

Opening 103 receives virgin aggregate material (VAM) and opening 105 receives recycled asphalt product (RAP).

The main drum 102 is divided into 3 zones, the pre-combustion zone 110, the combustion zone 120, and the post-combustion zone 130. The pre-combustion zone 110 is provided with veiling flights for dispersing the VAM as it passes through the pre-combustion zone 110. Pre-combustion zone 110 further has a plurality of mouse holes 114 which provide for limited amounts of VAM to pass therethrough to help scour the outer drum dispersing flights 118. Pre-combustion zone 110 further has a plurality of adjustable VAM inter-drum holes 116 for regulating the amount of VAM that passes into the partial outer drum 104. The adjustable VAM inter-drum holes 116 may be the results of adding or removing various panels 117 which can be added or removed, depending upon the operational parameters of any particular job.

Combustion zone 120 is where the heat for the pre-combustion zone 110 is generated by the flame 69. Counter-flowing heated air column 122 is shown moving in a direction counter to the direction of flow of the VAM and the RAP.

Post-combustion zone 130 is generally for combining and mixing elements. The pre-mixed RAP and VAM entry hole 132 is where the mixture of heated RAP and heated VAM enters the post-combustion zone 130 and is combined with still more VAM and liquid asphalt via spray 86. The combination is then mixed and output through output 140.

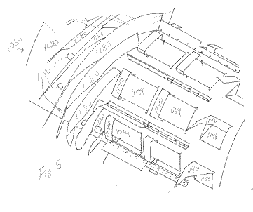

Now referring to FIG. 4, there is shown a cut-away perspective view of an embodiment of an asphalt plant 1000 of the present invention. Plant 1000 is a variation of plant 100 of FIG. 3. Not all components of plant 1000 are shown. Shown in a main inner drum 1020 having an elevated main inner drum inlet end 1030 for receiving therein VAM and a partial outer drum 1040 with a partial outer drum inlet end 1050, for receiving RAP therein. Not shown in FIG. 4 are the VAM and RAP conveyors, the burner and the liquid asphalt spray injector. It is understood that these details are known in the prior art and need not be shown.

Main inner drum inlet end 1030 receives the VAM and main inner drum spiral intake blades 1022 move the material from the inlet end into the interior of the drum where it can be heated. VAM veiling type drying flights 1024 are disposed on the inside surface of main inner drum 1020 for the purpose of creating a curtain or veil of VAM, as the drum is rotated during operation, so as to improve the efficiency of heating and drying the VAM. As the VAM proceeds downward through the main inner drum 1020, it approaches a flame output by a centrally disposed burner (not shown but disposed along a central axis and upward from the mixing flights). The inside temperature of main inner drum 1020 increases from the main inner drum inlet end 1030 to the burner. Heat shielding plates 1026 are added underneath the VAM veiling type drying flights 1024 in a section of the main inner drum 1020 nearer the burner. The density of VAM veiling type drying flights 1024 is shown as reduced in the area with heat shielding plates 1026; however, this need not be the case. The density of VAM veiling type drying flights 1024 is readily adjustable by having each of the VAM veiling type drying flights 1024 being independently mounted on the main inner drum 1020. As the VAM moves closer to the burner, temperature rises further. Scooping combustion zone insulating flights 1028 are shown in next section. These scooping combustion zone insulating flights 1028 have a relatively small gap along the leading edge; as the main inner drum 1020 is rotated, this gap allows VAM to enter into a shielded or insulated compartment as it proceeds through the main inner drum 1020 at points of increasing internal drum temperatures.

A partial outer drum 1040 is disposed concentrically about main inner drum 1020 with a partial outer drum inlet end 1050 for receiving RAP therein at some intermediate point along main inner drum 1020.

The partial outer drum inlet end 1050 is shown as starting at a point where the main inner drum 1020 has scooping combustion zone insulating flights 1028; however, it could begin at an earlier or later point along the main inner drum 1020 and the flights coinciding with the partial outer drum inlet end 1050 can be any type of flight.

One general purpose of the partial outer drum 1040 is to provide for a preheating of the RAP prior to introduction into the main inner drum 1020 at a point where it is not subject to the high temperatures associated with direct exposure to the flame from the burner.

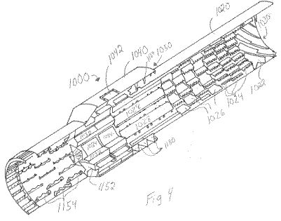

Now referring to FIGS. 4 and 5, like the main inner drum 1020, the partial outer drum 1040 has at its partial outer drum inlet end 1050 one or more RAP partial outer drum spiral intake blades 1180 which are provided and configured to move RAP from the partial outer drum inlet end 1050 into the partial outer drum 1040. The RAP partial outer drum spiral intake blades 1180 may be mounted on the main inner drum 1020 or the partial outer drum 1040 or both. VAM main inner drum exiting mouse holes 1140 may be disposed through main inner drum 1020. One purpose of VAM main inner drum exiting mouse holes 1140 is to provide an avenue for limited amounts of VAM to enter the partial outer drum 1040 so as to help clean the inside of partial outer drum 1040 as it may be susceptible to problems associated with heating of RAP which may become sticky. The VAM may act as a scouring agent to help maintain flow of RAP through the partial outer drum 1040. VAM main inner drum exiting mouse holes 1140 may be adjustable in size to address the scouring needs of the particular situations. Large mouse holes 1160 are shown.

The VAM will normally proceed down through the main inner drum 1020 into a combustion zone having the scooping combustion zone insulating flights 1028. Main inner drum 1020 may have additional holes therein to permit more VAM to exit the main inner drum 1020 and enter the partial outer drum 1040.

Burner zone flights 1032 are shown disposed above burner zone inner drum adjustable exit openings 1034. A purpose of burner zone inner drum adjustable exit openings 1034 is to permit even more VAM to exit the main inner drum 1020 and thereby avoid traversing the highest temperature areas within the main inner drum 1020. Burner zone inner drum adjustable exit openings 1034 are made adjustable by at least partially covering them with plates (not shown). These partial plates may be stainless steel.

After the burner zone inner drum adjustable exit openings 1034 allow passage of VAM into the partial outer drum 1040, the VAM is deflected by deflectors 1142 and caused to move more in a downward direction through the partial outer drum 1040.

After the workers access opening 1042, the partial outer drum 1040 tapers down to and attaches to the main inner drum 1020. Nearly adjacent to the point where partial outer drum 1040 meets with main inner drum 1020, there are outer drum exit channel deflectors 1146 which help to channel the material in partial outer drum 1040 through the outer drum exit channels 1148.

Once the material from the partial outer drum 1040 is emptied into the main inner drum 1020, it proceeds through the outer drum exit channel chutes 1152. At this time, the VAM and RAP are mixed together with an asphalt liquid in an area behind the burner and out of the flow of hot gases emanating from it and being propelled out the main inner drum inlet end 1030. Mixing flights 1154 are included to facilitate thorough mixing of the RAP, VAM and an asphalt liquid.

The newly formed asphalt is then discharged from the main inner drum 1020 for subsequent use.

It is believed that when these teachings are combined with the known prior art by a person skilled in the art of asphalt drum design and operation, many of the beneficial aspects and the precise approaches to achieve those benefits will become apparent.

It will be understood that certain features and sub-combinations are of utility and may be employed without reference to other features and sub-combinations. This is contemplated by and is within the scope of the claims.

Since many possible embodiments may be made of the invention without departing from the scope thereof, it is understood that all matter herein set forth or shown in the accompanying drawings is to be interpreted as illustrative and not in a limiting sense.

We claim:

1. An asphalt counter-flow drum comprising:
a first main drum, configured to rotate around a longitudinal axis;
the first main drum comprising a front end, an intermediate section and a rear end;
the first main drum comprising a pre-combustion zone, disposed at the front end, a combustion zone, disposed in the intermediate section, and a post-combustion zone, disposed at the rear end;
the pre-combustion zone comprising a member disposed therein to assist in movement of material;
the combustion zone comprises a burner for generating a moving heated column of gas moving along the longitudinal axis, from the intermediate section to the front end;
the post-combustion zone comprises a means for introducing and mixing liquid asphalt with a recycled asphalt product (RAP) and virgin aggregate material (VAM);
a partial outer drum, fixed to portions of the first main drum, and extending around the combustion zone and a rear portion of the pre-combustion zone and a front portion of the post-combustion zone;
the first main drum comprising a first exit hole disposed in the rear portion of the pre-combustion zone, to allow material to pass from the first main drum into the partial outer drum;
the first exit hole having a first exit hole area characteristic; and
the first main drum further comprising a first entry hole disposed in the front portion of the post-combustion zone, to allow a combination of RAP and VAM to pass from the partial outer drum into the first main drum.

2. The apparatus of claim 1 wherein the first exit hole has an adjustable size characteristic for controlling an amount of VAM entering the partial outer drum.

3. The apparatus of claim 2 wherein the first exit hole further has an adjustable shape characteristic.

4. The apparatus of claim 2 further comprising a plurality of members disposed in the first main drum to assist in the dispersal of material.

5. The apparatus of claim 4 wherein the plurality of members is a plurality of veiling flights disposed on an inside surface of the first main drum and extending partially toward the longitudinal axis.

6. The apparatus of claim 1 further comprising a second exit hole disposed between the first exit hole and the front end and having a second exit hole area characteristic.

7. The apparatus of claim 6 wherein the second exit hole area characteristic is substantially smaller than the first exit hole area characteristic.

8. The apparatus of claim 7 further comprising an outer material moving member, disposed between the partial outer drum and the first main drum, and sized and positioned to cause RAP to move along the longitudinal axis when the first main drum is rotated about the axis.

9. The apparatus of claim 8 wherein the outer material moving member extends at least from the first exit hole to the second exit hole, and performs an augering function.

10. An asphalt plant comprising:
a drum comprising a front end opening and a rear discharge end, the drum rotates around a longitudinal axis;
a means for heating aggregate material;
a means for permitting movement of aggregate material disposed in the drum to exit the drum, traverse a longitudinal portion of the drum, while moving along a line substantially parallel to the longitudinal axis and substantially extending in a direction from the front end opening toward the rear discharge end and subsequently re-enter the drum; and
a means for introducing asphalt liquid to aggregate material that has re-entered the drum.

11. The asphalt plant of claim 10 wherein:
the means for heating is a burner disposed in a combustion zone disposed between the front end opening and the rear discharge end;
the means for introducing asphalt liquid comprises a conduit extending toward the drum and an orifice for permitting asphalt liquid to contact aggregate material; and
the means for permitting movement comprises a partial outer cylinder disposed concentrically around a portion of the drum such that aggregate material can be simultaneously within the partial outer cylinder and separated from the burner by a portion of the drum.

12. The apparatus of claim 11 further comprising:
means for introducing virgin aggregate material into the drum; and
means for introducing recycled asphalt products into a partial drum disposed concentrically about the drum.

13. A method of making hot mix asphalt comprising:
providing a rotating drum, having a front inlet end and a rear end;
introducing aggregate material into the rotating drum, at the front inlet end;
heating the aggregate material, with a flow of gases substantially in a direction counter to a direction from the front inlet end to the rear end;
moving, through an exit opening disposed between the front inlet end and the rear end, a first portion of the aggregate material outside of the drum;
moving, to a drum re-entry opening disposed between the front inlet end and the rear end, the first portion of the aggregate material;
permitting the first portion of the aggregate material to re-enter the drum at the re-entry opening;
introducing, at a location between the re-entry opening and the rear end, asphalt liquid to the aggregate material; and
discharging hot mix asphalt.

14. The method of claim 13 further comprising the steps of:
moving, through a hole disposed between the front inlet end and the rear end, a second portion of the aggregate material outside of the drum;
moving, to a drum re-entry opening disposed between the front inlet end and the rear end, the second portion of the aggregate material;
permitting the second portion of the aggregate material to re-enter the drum at the re-entry opening;
wherein the distance between the hole and the front end is shorter than the distance between the exit opening and the front end and the hole has a substantially smaller area than the exit opening.

15. The method of claim 13 further comprising the steps of:
removing a panel, which is configured for rapid detachment from and reattachment to the rotating drum and thereby increasing an amount of material which is permitted to exit, at any one time, the rotating drum at a point between the front inlet end and the rear end.

16. The method of claim 13 further comprising the step of:
introducing recycled asphalt products into a drum disposed concentrically around the rotating drum.

17. The method of claim 16 wherein the aggregate material is virgin aggregate material.

18. A method of making hot mix asphalt comprising the steps of:
providing a first rotating drum;
providing a second rotating drum;
introducing virgin aggregate material into the first rotating drum;
simultaneously introducing recycled asphalt products into the second rotating drum;
causing virgin aggregate material to exit the first rotating drum and mix with recycled asphalt products in the second rotating drum, to form a mixture of virgin aggregate material and recycled asphalt products;
causing the mixture to enter the first rotating drum; and
introducing liquid asphalt material to the mixture to form hot mix asphalt.

19. The method of claim 18 wherein the first rotating drum is disposed within the second rotating drum.

20. The method of claim 18 wherein the second rotating drum is attached to the first rotating drum.

21. A counter flow asphalt plant comprising:
a cylinder comprising an internal burner for heating material in a central segment of the cylinder;
a means for receiving into the cylinder non-recycled asphalt products;
a means for receiving recycled asphalt products; and
a means for by-passing non recycled asphalt products from the central segment of the cylinder and subsequently re-entering the cylinder in a lower segment.

22. A counter flow asphalt plant comprising:
a first elongated cylindrical drum having an elevated material inlet end and a rear discharge end;
a second cylindrical drum, concentrically disposed around the first elongated cylindrical drum, and having a second drum inlet end and spiral intake blades therein to auger recycled asphalt products further into the second cylindrical drum;
the first elongated cylindrical drum having a first plurality of holes therein configured to permit a first amount of virgin aggregate material to exit a central segment of the first elongated cylindrical drum and enter the second cylindrical drum at an intermediate point along the spiral intake blades;
a second plurality of holes in the first elongated cylindrical drum, each having a larger opening size than each of said first plurality of holes; the second plurality of holes being located lower than said first plurality of holes; and
structure disposed in said second cylindrical drum to urge a mixture of recycled asphalt products and virgin aggregate material from inside said second cylindrical drum through a third plurality of holes in the first elongated cylindrical drum, where each of the third plurality of holes are located below each of the second plurality of holes.
